(19) United States
(12) Patent Application Publication
(10) Pub. No.: US 2007/0136090 A1
(43) Pub. Date: Jun. 14, 2007

(54) System and method for macro-enhanced clinical workflow

(75) Inventors: Heidi Loutzenhiser, Portland, OR (US); Fred Masarie, Portland, OR (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/302,180

(22) Filed: Dec. 12, 2005

(51) Int. Cl. G06Q 10/00

(52) U.S. Cl. 705/2

(57) ABSTRACT

The present invention provides a method and system for macro-enhanced clinical workflow. The method and system enables printing of a prescription form, a laboratory test form, and a medical information handout based on at least user input to an electronic medical record (“EMR”). The method and system also enables the ordering one or more of a drug prescription, a laboratory test, and a medical procedure based on at least user input to the EMR. The method and system additionally provides for notifying a user of one or more of a drug interaction, a recommended medical procedure, and a result of at least one of a previous medical procedure, previous laboratory test, and a failure of the patient to follow-up to a physician request based on at least user input to the EMR.

### BACKGROUND OF THE INVENTION

The present invention generally relates to electronic medical records. Specifically, the present invention provides a system and method for macro-enhanced clinical workflow.

Current medical record systems record medical histories of patients. Such systems may record medical histories on paper or may record the medical histories electronically. Electronically stored medical records are known as Electronic Medical Records (“EMR”).

Paper medical records are typically recorded in a chronological order. That is, paper medical records are created by adding more recent medical data to previous medical data in the record. Such an order makes it difficult for a physician to search a patient's medical history. For example, a physician wishing to prescribe a new medication to a patient must first search most, if not all, of a patient's medical history in order to avoid prescribing a drug that may cause an adverse drug reaction with a current drug prescription.

In general, EMR may be electronically searched. In this way, a physician may electronically search an EMR for possible adverse drug reactions. However, such a manual searching method is still prone to errors as a physician may not search for the proper terms in the EMR and previous physicians may fail to record all relevant medical data. In addition, current EMR systems do not provide for the automatic communication of prescription orders, laboratory test orders, and/or orders for medical procedures. For example, with current EMR systems and methods, after searching a patient's EMR for possible adverse drug reactions, the physician must print out or physically write a prescription form, give the form to the patient, and trust that the patient takes the prescription to a pharmacy to obtain the prescribed drugs. Similarly, with laboratory tests and/or orders for medical procedures, physicians currently must create the order for the laboratory and/or hospital, give the order to the patient, and trust that the patient actually has the test and/or procedure completed.

In addition, current EMR systems and methods do not provide for automated notification of possible adverse drug reactions. Current systems and methods require the physician to personally identify possible adverse drug reactions and alter drug prescriptions accordingly. This may involve considerable time for a physician to search through an EMR and is prone to human error.

Current systems and methods also do not automatically recommend medical procedures based on a patient's medical history. Again, a physician must review a patient's entire medical history and develop his or her own recommended medical procedures. Such a process is prone to human errors, as a physician may not always remember various recommended procedures based on one or more patient factors contained in the medical history. In addition, all relevant patient factors may not be readily found by a physician. For example, a physician may be mentally incapable of remembering a large number of relevant medical events and/or details in a patient's medical history when the events and/or details are physically and/or temporally spaced far apart in the medical history.

Thus, a need exists for a system and method of a macro-enhanced clinical workflow. Such a system and method can provide for automated searching of a patient's EMR to enable the automatic printing of relevant medical forms, automatic ordering of a prescription, laboratory test and/or medical procedure, and automatic notification to a user of possible drug interactions, recommended medical procedures, and medical results.

### BRIEF SUMMARY OF THE INVENTION

The present invention provides a computer-readable storage medium including a set of instructions for a computer. The set of instructions include an input comparison routine and an output determination routine. The input comparison routine compares user input to one or more of a patient medical history and a criteria list. The output determination routine automatically determines one or more outputs based on at least a comparison between the input and one or more of the medical history and the criteria list. The outputs include at least one of a printed form, an electronically communicated order, and a notification.

The present invention also provides for a method of macro-enhanced clinical workflow. The method includes providing an electronic medical record for a patient, entering user input into the record, and based on at least said user input, automatically performing one or more of the steps of: printing one or more of a prescription form, a laboratory test form, and a medical information handout, ordering one or more of a drug prescription, a laboratory test, and a medical procedure, and notifying a user of one or more of a drug interaction, a recommended medical procedure, and a result of at least one of a previous medical procedure, previous laboratory test, and a failure of the patient to follow-up to a physician request. The medical record includes a patient medical history.

The present invention also provides for a macro-enhanced clinical workflow system. The system includes an electronic medical record associated with a patient and a set of instructions stored on a computer-readable medium. The instructions direct an output device to automatically perform one or more of the steps of: printing one or more of a prescription form, a laboratory test form, and a medical information handout, ordering one or more of a drug prescription, a laboratory test, and a medical procedure, and notifying the user of one or more of a drug interaction, a recommended medical procedure, and a result of at least one of a previous medical procedure, previous laboratory test, and a failure of the patient to follow-up to physician request. The instructions direct the output device based on at least a comparison of user input added to the medical record and one or more of the medical record and a criteria list. The medical record includes a patient medical history.

The present invention also provides a method for automating an electronic medical record system. The method includes adding medical data to an electronic medical record, comparing the medical data to second medical data previously added to the medical record, and based on at least the comparing step, communicating at least one of a notification, an alert, and a recommendation to a user.

### BRIEF DESCRIPTION OF SEVERAL VIEWS OF THE DRAWINGS

FIG. 1 illustrates a macro-enhanced clinical workflow system used in accordance with an embodiment of the present invention.

FIG. 2 illustrates an exemplary EMR form used in accordance with an embodiment of the present invention.

FIG. 3 illustrates a flowchart for a method for macro-enhanced clinical workflow used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

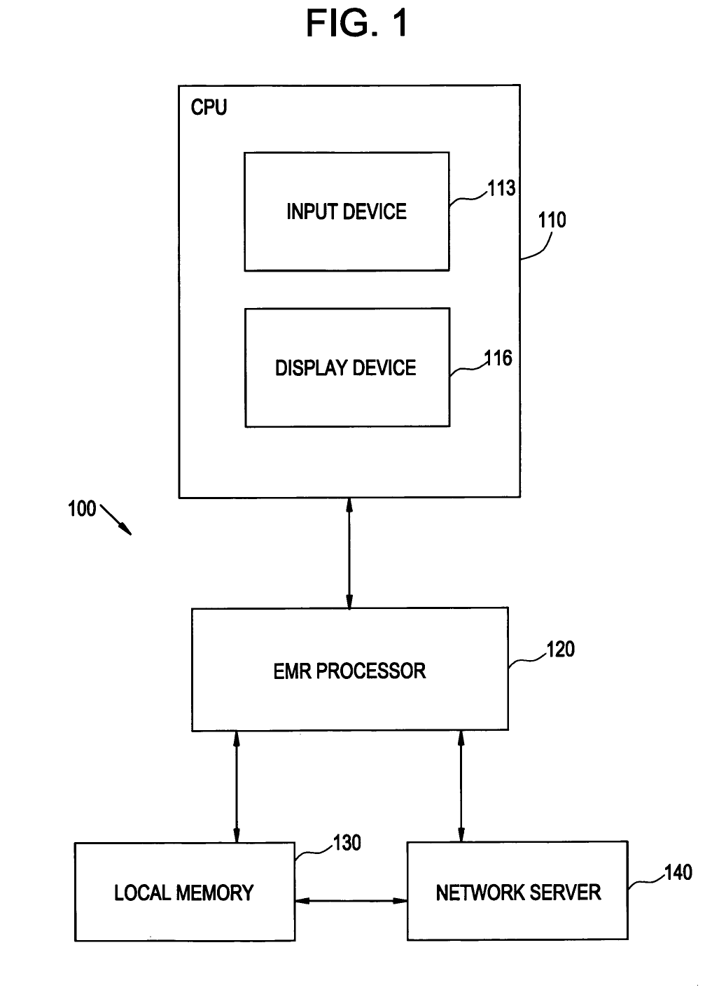

FIG. 1 illustrates a macro-enhanced clinical workflow system 100 used in accordance with an embodiment of the present invention. System 100 includes a computer (“CPU”) 110, an electronic medical record (“EMR”) processor 120, and a local memory 130. In an embodiment of the present invention, system 100 may also include a network server 140 in addition to or in place of local memory 130. CPU 110 communicates with EMR processor 120. EMR processor 120 communicates with CPU 110 and local memory 130. EMR processor 120 may also communicate with network server 140. Local memory 130 communicates with EMR processor 120. Local memory 130 may also communicate with network server 140.

In operation, a user employs CPU 110 to retrieve an EMR for a patient. The user may be, for example, a doctor, physician, nurse, surgeon, hospital administrator, or any other individual wishing to examine a patient's EMR. In another embodiment, the user may create an EMR for a patient.

CPU 110 can include an input device 113 and a display device 116. Input device 113 may be employed to retrieve and/or create the EMR, for example. Input device 113 can include any device capable of allowing a user to input data into CPU 110 such as a keyboard, mouse, or keyboard and touch screen combination, for example.

The CPU 110 may retrieve the EMR from EMR processor 120. EMR processor 120 may obtain the EMR from local memory 130 and/or network server 140. Once CPU 110 receives the EMR, display device 116 may display one or more forms of the EMR. In this way, a patient's medical history (stored as an EMR) may be presented to a user (via display device 116).

In another embodiment of the present invention, the CPU 110 may retrieve the EMR directly from one or more of local memory 130 and network server 140.

The EMR can include one or more electronic forms representing medical data. For example, an EMR can include data representing previous medical examinations (such as a lipid profile or hemoglobin A1C measurement), details concerning previous visits to a physician, previous symptoms, and previous medical procedures. In addition, an EMR can be tailored to one or more medical specialties, such as cardiology, dermatology, or orthopedics, for example. A cardiology EMR can include, for example, electronic forms including details of a patient examination, a patient intake form, a work status report, results of a cardiac examination, a cholesterol clinic progress report, an EKG report, and/or a recommended exercise and diet plan.

In general, an EMR includes electronic data representative of information typically recorded in paper medical charts and histories for a patient.

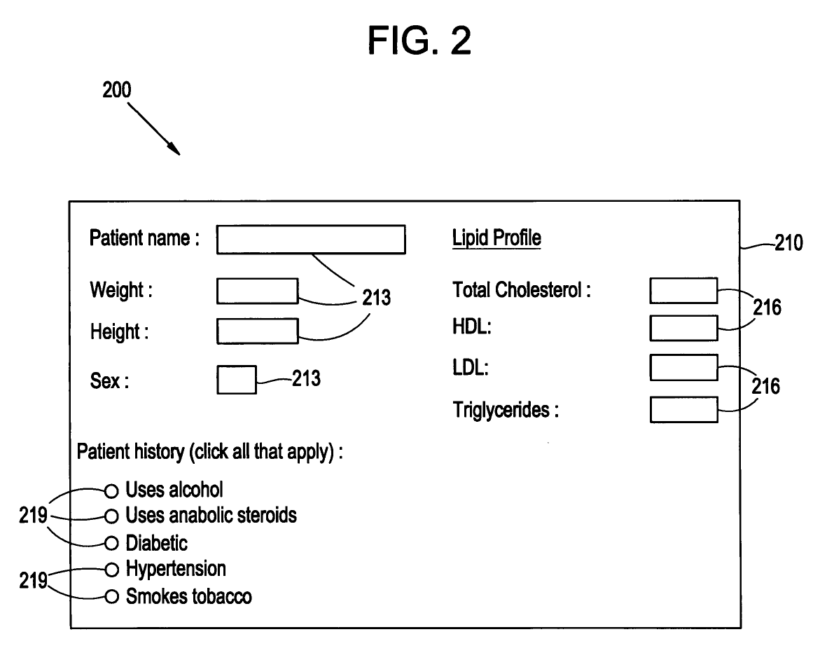

The EMR can also include electronic forms that may be completed by the user. For example, the EMR can include an electronic form for entering a patient's weight, height and blood pressure measurements. The form may include several fields and/or radio buttons for the user to type in corresponding medical data. FIG. 2 illustrates an exemplary EMR form 210 used in accordance with an embodiment of the present invention. Form 210 includes a plurality of character fields 213, number fields 216, and radio buttons 219. While several fields 213, 216 and buttons 219 are shown, any number of fields 213, 216 and/or buttons 219 may be used, including single fields 213, 216 and/or buttons 219 or no fields 213, 216 and/or buttons 219. The fields 213, 215 and buttons 219 shown in FIG. 2 are intended as examples and are not to be construed as a limitation on the prevent invention.

Form 210 may be employed by a user to record medical data in the EMR. For example, using input device 113, the user may type in the patient's name, weight, height, and gender in the respective character fields 213. The user may also input results from a laboratory test that included a lipid profile by typing the results in number fields 216. The user may also employ input device 113 to “click” on one or more radio buttons 219 to indicate that the patient uses alcohol, anabolic steroids, or tobacco, is diabetic, or suffers from hypertension, for example.

In another embodiment of the present invention, one or more of fields 213, 216 and/or buttons 219 may have characters, numbers or other data already present in one or more fields 213, 216 or have one or more buttons 219 selected when the EMR (and corresponding form 210) is first accessed. For example, form 210 may already have the patient's name, height, weight and gender previously entered and saved into fields 213. In another example, fields 216 may already include the patient's lipid profile numbers when form 210 is first accessed.

In general, an EMR includes medical data corresponding to a medical history of a patient. A patient's medical history can include any information related to medical symptoms, problems, injuries, treatments, examinations, laboratory test results, or any other medically relevant events. In this way, an EMR may serve many of the same purposes as paper medical records commonly used by today's physicians.

As described above, the EMR is retrieved by EMR processor 120 from one or more of local memory 130 and network server 140. EMR processor 120 may include any computer processor capable of one or more of adding data to an existing EMR, creating a new EMR, saving an EMR to local memory 130 and/or network server 140, and retrieving an EMR from local memory 130 and/or network server 140. For example, EMR processor 120 may be a computer processor. EMR processor 120 and CPU 110 may be embodied in separate physical units (for example, as two physically distinct computers) or as a single physical unit (for example, EMR processor 120 may be a computer processor with loadable software on CPU 110).

Processor 120 may operate according to a set of instructions stored on a computer-readable storage medium. For example, processor 120 may operate according to a software program permanently or temporarily stored on a computer hard drive. The set of instructions may include one or more routines directing the actions of processor 120, as explained in more detail below. 100311 Once a user has retrieved an EMR (using processor 120), the user may input medical data into the EMR using CPU 110. The medical data may include, for example, a symptom, a laboratory test result, a recommended treatment, a currently prescribed drug, a currently prescribed medical treatment, a recommended drug and a recommended medical treatment.

After the user has input medical data into the EMR, CPU 110 communicates the EMR and the medical data (as user input) to processor 120. Processor 120 then examines the EMR to determine if one or more of several actions are to be taken. For example, processor 120 may examine EMR to determine what data has been recently added to the EMR. Processor 120 may then compare the newly added data to a rule or criteria list.

Processor 120 may compare the input to a patient medical history stored in an EMR and/or a criteria/rule list according to an input comparison routine. The input comparison routine may be a software routine included in the set of instructions directing the actions of processor 120. For example, the input comparison routine may direct processor 120 to compare the input results of a laboratory examination to a list of threshold results included in a criteria list. The comparison may reveal that one or more of the laboratory results exceed one or more thresholds stored in the criteria list, for example.

In an embodiment of the present invention, this comparison of the input to a medical history and/or a criteria list occurs automatically upon receipt of the input.

In another embodiment of the present invention, the user may input medical data into the EMR using voice-recognition software. The software may interpret the user's vocal commands and send corresponding input to processor 120, similar to as described above.

A rule or criteria list may be embodied in any logical analysis method that examines the presence or absence of one or more factors in order to determine what (if any) actions should be taken. A factor may include, for example, a threshold quantity for comparison to a measured amount. For example, a rule list may direct processor 120 to warn the user if a recently entered blood glucose measurement exceeds a given threshold glucose level. A factor may also include, for example, a medical event. A medical event can include any occurrence is a patient's lifetime that is medically relevant. For example, upon comparison of a user input of “CHEST PAINS” to a patient's medical history that includes abnormally high cholesterol readings, a rule list may direct processor 120 to warn the user that the patient is at a high risk for a heart attack.

A criteria list may also include a medical protocol. A medical protocol can include, for example, a standard medical recommendation for the general public or for some segment of the public. For example, a standard medical recommendation for the general public may include a recommendation that each person be examined by a physician at least once a year. Therefore, after a patient's medical record is accessed, processor 120 may examine a criteria list that directs processor 120 to determine the last time a patient was given a general physical each time processor 120 accesses the patient's EMR. Processor 120 may then compare the date of the patient's last physical (stored in the patient's EMR) to the current date. If more than a year has passed, the criteria list may direct processor 120 to notify the physician and recommend that the patient undergo a general physical, for example.

A standard medical recommendation for a segment of the public may include a recommendation that all women over the age of 45 receive annual mammogram examinations or that all diabetics have regular foot and/or eye examinations, for example. Thus, after a 50-year old female patient's medical record is accessed, processor 120 may examine a criteria list that directs processor 120 to determine the patient's gender and age. Upon doing so, the criteria list may then direct processor 120 to determine the last time the patient was given a breast exam. Processor 120 may then compare the date of the patient's last breast examination (stored in the patient's EMR) to the current date. If more than a year has passed, the criteria list may direct processor 120 to notify the physician and recommend that the patient undergo a breast examination, for example.

Processor 120 may also compare user input to a criteria list to obtain a medical treatment plan. For example, upon receiving user input that a patient wishes to stop smoking, processor 120 may consult the criteria list and obtain a medical treatment plan for the cessation of tobacco use.

Processor 120 may also examine and compare several text inputs to a list of symptoms included in the criteria list. For example, processor 120 may determine that “DECREASED APPETITE”, “FREQUENT URINATION”, and “WEIGHT LOSS” were entered into the EMR in one or more fields 213, 216 dedicated to patient symptoms. Processor 120 may then search a list of symptoms contained in the rule list for “DECREASED APPETITE”, “FREQUENT URINATION”, and “WEIGHT LOSS”, or any combination thereof, including searching each text item separately. If processor 120 does find the text in the rule list, processor 120 may then examine the rule list to determine what corresponding action is to be taken. For example, the rule list may recommend the physician administer a blood glucose test to the patient to check for diabetes in response to the “DECREASED APPETITE”, “FREQUENT URINATION”, and “WEIGHT LOSS” symptoms entered into the EMR. The rule list may also recommend that the physician be notified of a preliminary diagnosis. For example, based on at least user input into the EMR and processor 120's comparison of the input to the rule list, the rule list may reveal a preliminary diagnosis that a patient may have diabetes.

The rule list can recommend processor 120 automatically take one or more steps in response to user input. In an embodiment of the present invention, a set of instructions stored on a computer-readable storage medium may determine one or more outputs, as described above. For example, the set of instructions may include an output determination routine. Based on at least a comparison of user input to one or more of a patient medical history and a criteria list (as described above), the output determination routine may determine one or more outputs to be generated. For example, the generated output(s) may include one or more of a printed form, an electronically communicated order, and a notification, as described in more detail below.

In an embodiment of the present invention, the criteria/rule list can be customizable to each of a plurality of users. For example, a physician may desire to alter the criteria list examined by processor 120. The physician may wish, for example, to alter a threshold cholesterol reading or list of symptoms, for example.

In an embodiment of the present invention, the criteria/rule list can be automatically customized when a user begins using the present invention. For example, a user may have a customizable criteria list stored on a memory accessible by processor 120. Upon logging on to the computer system associated with the present invention, processor 120 may begin accessing the customized criteria list associated with the current user. In this way, several physicians may have customized criteria lists that are automatically loaded upon logging on to the computer system.

In an embodiment of the present invention, the rule list may recommend processor 120 communicate one or more of a prescription form, a laboratory test form, a physician letter, and a medical information handout to an output device (not shown in FIG. 1). The output device may include a printer, for example. The output device may then print the prescription form, laboratory test form, or medical information handout.

The prescription form can include any form that allows a patient to receive one or more medications from a pharmacy, for example. In this way, a patient may retrieve the printed prescription form from the output device and give the form to a pharmacy, which may then give the patient the corresponding prescribed medication(s).

The laboratory test form can include any form that allows a patient to go to a medical laboratory and receive one or more laboratory tests. A laboratory test may include, for example, a blood test such as a lipid profile or a hemoglobin A1C measurement. In this way, the patient may retrieve the laboratory test form from the output device and take the form to a medical laboratory, which may then administer the corresponding laboratory tests.

The medical information handout can include textual information concerning one or more medical symptoms, treatments, or procedures, for example. In general, a medical information handout is a printed handout that includes information to inform a patient of a medical condition. For example, if a patient has been taken to an emergency room for a head concussion injury, upon leaving the hospital the patient may receive a medical information handout related to head injuries. The handout may instruct the patient to be aware of certain symptoms and come back to the hospital if the symptoms occur, such as nausea, dizziness, or increased difficulty in awaking from sleep, for example. The handout may also inform the patient of ways to treat symptoms related to the injury at home, for example.

The physician letter can include any letter commonly communicated between two or more physicians concerning a patient. For example, a physician letter can include a letter for the patient to sign so that the patient's paper and/or electronic medical record be made available to another physician. In another example, a physician letter can include a referral letter from a physician to another physician, counselor, physical therapist, or any other medical health professional.

In an embodiment of the present invention, any one or more of the printed forms discussed herein may be customizable to a given patient. For example, the form may be automatically customized to one or more of a patient's name, list of symptoms associated with the patient, results from a previous laboratory examination or recommended treatment plan.

The type of form determined by the output determination routine can be based on at least the medical data input to the EMR by the user. For example, a patient may notify a physician that he is suffering from lower back pain. The physician may then retrieve the patient's EMR and input the patient's symptoms into the EMR using CPU 110. Once the EMR is communicated to processor 120, processor 120 examines the newly entered data related to the patient's symptoms. Processor 120 may then compare the symptoms to the rule list. The rule list may direct processor 120 to communicate a prescription form for painkilling medication and a medical information handout concerning home treatment of lower back pain to the output device.

The output determination routine may also direct processor 120 to order one or more of a drug prescription, a laboratory test, a physician referral, and a medical procedure. A drug prescription order can include any request for one or more medications to be administered to a patient. For example, a drug prescription order communicated to a pharmacy can cause the pharmacy to prepare the medication(s) for the patient without requiring the patient to bring a prescription order form to the pharmacy. In this way, a prescription for one or more medications may quickly and automatically ordered from a pharmacy, without having to wait for a prescription form to be printed up and signed by a physician.

An order may be communicated in any electronic manner through an output device connected to processor 120. The output device can include any device capable of electronic communication over either a wired or wireless connection. The communication may occur over any number of communication methods, including, for example, an Internet connection, an intranet network, or a wireless network. For example, processor 120 may communicate a prescription order to a pharmacy through server 140.

A laboratory test order can include any request for one or more laboratory tests to be administered to a patient. For example, a laboratory test order communicated to a medical laboratory can cause the laboratory to administer a lipid profile to the patient, for example. In this way, a medical laboratory may receive a laboratory order and begin preparing for the patient's laboratory test without having to wait for a laboratory test form to be printed up, signed by a physician, and brought to the laboratory.

A medical procedure order can include any request for one or more medical procedures to be administered to a patient. For example, a medical procedure order communicated to another physician in the same or different hospital can direct the physician for perform a medical procedure on the patient. For example, a medical procedure order may be used by a first physician to request that a second physician perform a medical procedure on the patient that first physician is incapable of performing. Such a medical procedure may include x-ray imaging or a surgical procedure, for example.

A physician referral can include any referral of a patient to another physician for medical treatment. For example, a physician referral can include one physician referring a patient to another physician in the city where the patient is moving. In another example, a physician referral can include a physician referring a patient to another medical healthcare provider, such as a physical therapist, for treatment.

Processor 120 may order the prescription, test, referral and/or procedure by communicating the order(s) to network server 140. The order(s) may be communicated automatically upon receipt of user input. The order(s) may then be communicated to one or more recipients (not shown) also in communication with network server 140. The recipients may include, for example, a pharmacy, a hospital, and/or a physician. For example, a prescription order may be communicated from processor 120 to network server 140, then from server 140 to a pharmacy. Similarly, a laboratory test order may be communicated from processor 120 to network server 140, then from server 140 to a medical laboratory. Similarly, a medical procedure order may be communicated from processor 120 to network server 140, then from server 140 to a hospital or clinic. In this way, based on at least medical data input into an EMR, processor 120 may automatically order medications, laboratory tests, or medical procedures directly from respective providers without requiring additional paperwork and/or delay.

The output determination routine may also direct processor 120 to notify a user of one or more of a drug interaction, a recommended medical procedure, and a result of at least one of a previous medical procedure, previous laboratory test, and a failure of said patient to follow-up to a physician request. A drug interaction can include a determination that a plurality of medications prescribed to the patient may have adverse effects when taken together (for example, an adverse drug reaction). The drug interaction may be based on a comparison between two or more previously prescribed medications or between a previously prescribed medication and a medication that a user desires to prescribe to the patient. For example, a user may input a drug prescription order into an EMR. Processor 120 may then search a rule list to find the prescribed medication. The rule list may then include a list of medications that can have adverse effects on a patient when combined with the prescribed medication. Based on at least this list, processor 120 may then communicate a notification to CPU 110.

A drug interaction may also include a known drug allergy interaction. For example, a patient's medical history may reveal a known drug allergy to a drug ordered by a physician. The output determination routine may then direct processor 120 to notify the physician of the known allergy.

A recommended medical procedure can include a procedure to be administered to a patient based on medical data saved in and/or input into EMR. For example, a patient's EMR may include data representing a history of poor diet, high cholesterol, and a sedentary lifestyle. A physician may then order a lipid profile for the patient. Based on the results of the lipid profile entered into the EMR, processor 120 may examine the rule list to determine which, if any, medical procedures are recommended based on at least a patient's medical data stored in EMR. The rule list may include a recommendation of a stress test for the patient based on the patient's history of poor diet, high cholesterol, and sedentary lifestyle in addition to the results of the lipid profile, for example. Based on at least this recommendation, processor 120 may communicate a notification to CPU 110 indicating that a stress test should be administered to the patient, for example. In this way, processor 120 may determine one or more medical procedures that may be recommended for a patient based on one or more factors, including a patient's medical history and user input recently entered into the patient's EMR, for example. Processor 120 may then automatically notify the user of the recommended medical procedures.

A result of at least one of a previous medical procedure, previous laboratory test, and a failure of said patient to follow-up to a physician request can include a message communicated to CPU 110 and displayed to the user. The message may include details on a previous medical procedure. For example, if processor 120 previously recommended that a patient undergo a stress test (as described above), the results of the stress test may be communicated from processor 120 to CPU 110 for display to the user. In another example, if a patient was examined by x-ray imaging, processor 120 may communicate x-ray images to CPU 110 for display on device 116.

The message may include results of a previous laboratory test. For example, if a medical laboratory recently tested a patient's blood, processor 120 may communicate a lipid profile resulting from the blood test to CPU 110. If several laboratory lab results are included in a patient's EMR, processor 120 may determine whish results to communicate to CPU 110 by examining a date corresponding to each laboratory result. Based on at least this date, processor 120 may determine which loboratory results to communicate.

The message may include a failure of a patient to follow-up to a physician request. For example, frequently physicians request that a patient meet with the physician concerning a medical treatment or new medication after a given amount of time from starting the medical treatment or medication. For example, many endocrinologists request that their diabetic patients meet with the endocrinologist every four months. Processor 120 may therefore notify an endocrinologist if a patient has not met with the physician in the previous four months, for example. In addition, processor 120 may notify a first physician of a patient's failure to follow-up with a second physician.

The notification communicated from processor 120 to CPU 110 may include any visual or audio indication. For example, the notification may include a text message displayed on display device 116. The notification may also include an alarm or a flashing light on display device 116, for example. The notification may also include an image or text message communicated to a printer to be printed for the user and/or physician.

Once a user is finished with an EMR (for example, the physician is finished entering medical data into the EMR or receiving notifications and/or recommendations based on the EMR), the user may store the EMR by directing processor 120 to store the EMR in at least one of local memory 130 and server 140. For example, processor 120 may store the EMR on a computer-readable memory located locally (as local memory 130) or on a network (as server 140). An EMR stored on server 140 may be accessible by a plurality of physicians, pharmacies, hospitals, and/or clinics, for example.

In another embodiment of the present invention, a user may input data into an EMR by activating a graphical icon on a computer screen. For example, input device 113 may include a computer mouse and display device 116 may include a computer monitor. One or more icons displayed on display device 116 can represent one or more types of user input. For example, a first icon may represent a prescription order form. When a user activates the first icon using the input device 113, a set of instructions stored on a computer-readable medium may direct processor 120 to display a prescription order form on display device 116, for example. The user may then fill in the various data fields of the form (similar to as described above in reference to FIG. 2). Once the form has been filled in, an input comparison routine can compare the data input into the fields of the form to one or more of a patient medical history and a criteria or rule list, as described above. The graphical icon can therefore act as a shortcut to a type of user input. The graphical icon can represent any one or more of an input to cause a form to be printed, an order to be automatically communicated, and a notification to occur, all as described above.

A user may therefore employ system 100 to automatically print a form, order a prescription, test, or procedure, and/or notify the user of a drug interaction, a recommended procedure, and/or a result of at least one of a previous procedure, laboratory test, and a failure to follow-up. As described above, processor 120 examines an EMR and/or medical data recently input into EMR in order to determine which steps are to be taken. In this way, based on one or more factors (such as previous laboratory test results, currently prescribed medications, and symptoms), system 100 may automatically provide for the printing of a prescription form, the ordering of a laboratory test, and a notification to the physician of an adverse drug reaction.

For example, imagine that a diabetic patient on vacation injures his knee. The patient heads to the local hospital for treatment of his knee injury. At the local hospital, a physician may access the patient's EMR using system 100 (including access to network server 140). After the patient tells the physician of his knee pain, the physician may enter the patient's symptoms into the EMR using CPU 110. Once the symptoms are communicated to processor 120, processor 120 may then compare one or more of the recently entered medical data (for example, the knee pain symptoms) and the medical data previously stored in the EMR to the stored rule list, as described above.

Processor 120 may then compare the patient's symptoms with other medical data of the EMR. Based on at least this comparison and reference to a rule list, processor 120 may notify the physician of a recommended medical procedure. The recommended medical procedure may include, for example, a list of possible drugs to treat the patient's knee pain, a recommendation for x-ray images of the patient's knee, and a physical therapy regimen. Processor 120 may then communicate a notification to the physician of the details of the recommended procedures.

Processor 120 may also determine that the patient is a diabetic. Processor 120 may then compare the recommended drugs to the rule list and determine that several of the recommended drugs may have an adverse drug reaction with the patient's current use of synthetic insulin. Processor 120 may then communicate a notification to the physician warning of the possible adverse drug reactions.

Processor 120 may also determine that the patient has not visited his endocrinologist for treatment of his diabetes in over one year. Processor 120 may make this determination based on a comparison of the date of the patient's current visit to the emergency room and the date of the patient's last visit with his endocrinologist in his hometown. Processor 120 may then compare this difference in dates to the rule list. This comparison may result in the rule list causing processor 120 to communicate a notification to the physician. The notification may recommend that physician administer a hemoglobin A1c examination to check on the quality of the patient's care of his diabetes.

Processor 120 may then cause an output device to automatically print a laboratory test form for a hemoglobin A1c test. Once the form has printed, the patient may take the test form to a medical laboratory at the hospital and have the hemoglobin A1c test administered.

Processor 120 may also order a drug not found to possibly cause an adverse drug reaction (as described above) from a pharmacy. As described above, processor 120 may automatically communicate the drug prescription to a pharmacy via network server 140.

Processor 120 may also automatically order a medical procedure, such as an x-ray examination, based on at least a comparison of the patient's knee pain symptoms and reference to the rule list. The order may be communicated to the x-ray imaging laboratory of the hospital via network server 140, for example. The x-ray imaging laboratory may then prepare for x-ray imaging of the patient's knee.

Processor 120 may also direct the output processor to print one or more medical information handouts. For example, processor 120 may direct that handouts describing home treatment of the patient's knee injury, symptoms of possible adverse side effects of the prescribed drug(s) (described above), and proper treatment of diabetes be printed by output device. In this way, system 100 may provide for a more complete and automated treatment of a patient's symptoms and injuries, while adding additional protection against, among other things, the prescription of adverse drugs to a patient, for example.

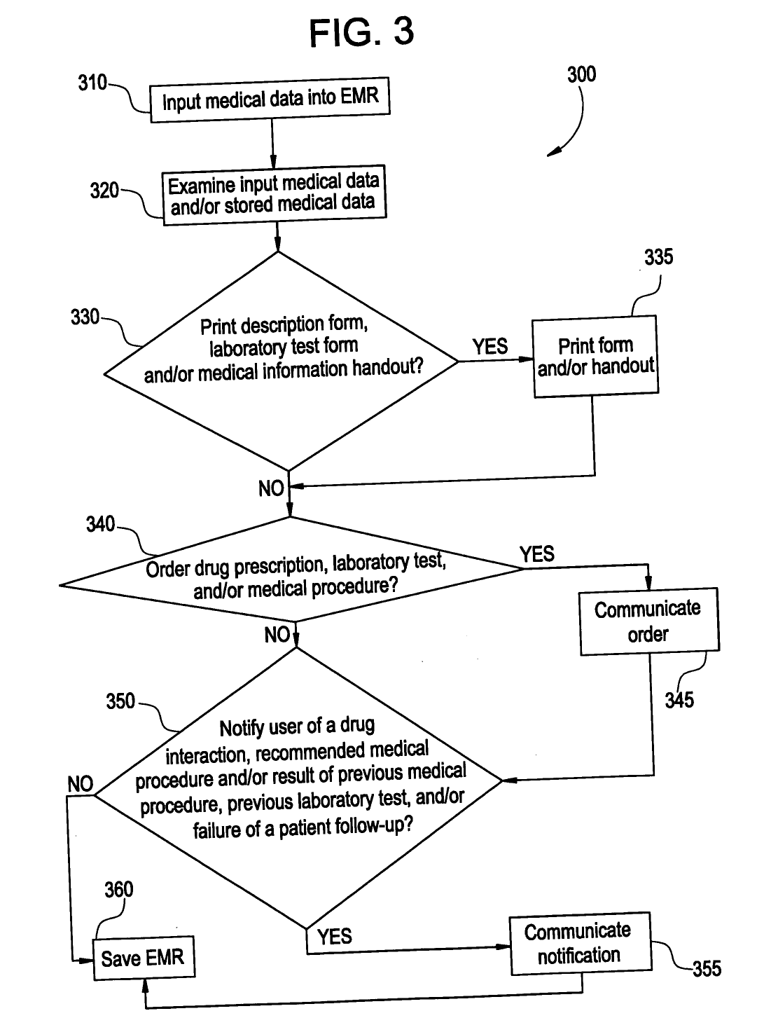

FIG. 3 illustrates a flowchart for a method 300 for macro-enhanced clinical workflow used in accordance with an embodiment of the present invention. First, at step 310, medical data is input in an EMR. Next, at step 320, the input medical data and/or medical data previously input into the EMR are examined, as described above. The examination may include a comparison of medical data to a threshold, a comparison of medical data, or reference to a rule or criteria list, as described above.

Next, at step 330, based on at least the examination of the medical data of the EMR at step 320, a determination is made as to whether a prescription form, a laboratory test form, and/or a medical information handout should be printed. If it is determined at step 330 that one or more of the forms and/or handout should be printed, method 300 proceeds to step 335 where the forms and/or handouts are printed, as described above. After step 335 or if at step 330 it is determined that no form or handout is to be printed, method 300 proceeds to step 340.

At step 340, based on at least the examination of the medical data of the EMR at step 320, a determination is made as to whether a drug prescription, a laboratory test, and/or a medical procedure should be ordered. If it is determined at step 340 that one or more of the drug prescription, laboratory test, and/or medical procedure should be ordered, method 300 proceeds to step 345 where the order is communicated to one or more of a pharmacy, physician, and hospital, as described above. After step 345 or if at step 340 it is determined that no drug prescription, laboratory test, and/or medical procedure is to be ordered, method 300 proceeds to step 350.

At step 350, based on at least the examination of the medical data of the EMR at step 320, a determination is made as to whether a user is to be notified of one or more of a drug interaction, a recommended medical procedure, and a result of at least one of a previous medical procedure, previous laboratory test, and a failure of said patient to follow-up to a physician request. If it is determined at step 350 that a notification is to be communicated to a user, method 300 proceeds to step 355 where the notification is communicated to the user, as described above. After step 355 or if at step 350 it is determined that no notification is to be communicated to a user, method 300 proceeds to step 360.

Next, at step 360, the EMR is saved on a computer-readable memory. For example, the EMR may be communicated to local memory 130 and/or network server 140 for storage, as described above.

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features that come within the spirit and scope of the invention.

What is claimed is:

1. A computer-readable storage medium including a set of instructions for a computer, said set of instructions including:
an input comparison routine comparing a user input to one or more of a patient medical history and a criteria list; and
an output determination routine automatically determining one or more outputs based on at least a comparison between said input and one or more of said medical history and said list, said outputs including at least one of a printed form, an electronically communicated order, and a notification.

2. The set of instructions of claim 1, wherein said input comparison routine includes a voice-recognition routine for interpreting vocal commands of said user.

3. The set of instructions of claim 1, wherein said criteria list includes one or more of a list of symptoms, threshold quantities, medical events, medical protocols, and medical treatment plans.

4. The set of instructions of claim 3, wherein said input comparison routine compares said input to said list of symptoms to determine a preliminary diagnosis.

5. The set of instructions of claim 4, wherein said preliminary diagnosis includes a medical treatment plan.

6. The set of instructions of claim 1, wherein said output determination routine further directs an output device to present said output to one or more of said user and a third party.

7. The set of instructions of claim 6, wherein said printed form includes one or more of a prescription form, a laboratory test form, a medical information handout, and a physician letter and said output determination routine directs a printer to print said printed form.

8. The set of instructions of claim 7, wherein said handout is customizable to a patient.

9. The set of instructions of claim 6, wherein said electronically-communicated order includes one or more of a drug prescription, a laboratory test, a medical procedure, and a physician referral, and said output determination routine communicates said order to one or more of a pharmacy, a laboratory, and a hospital.

10. The set of instructions of claim 6, wherein said notification notifies said user of one or more of a drug interaction, a recommended medical procedure, and a result of at least one of a previous medical procedure, previous laboratory test, and a failure of said patient to follow-up to a physician request,
wherein said output determination routine directs at least one of a display device and an audio device to present said notification to said user.

11. The set of instructions of claim 1, wherein said user input includes activating a graphical icon.

12. The set of instructions of claim 1, wherein said criteria list is automatically customizable to one or more physicians.

13. A method for macro-enhanced clinical workflow, said method including:
providing an electronic medical record for a patient, said medical record including a patient medical history;
entering user input into said record; and
based on at least said user input, automatically performing one or more of the steps of:
printing one or more of a prescription form, a laboratory test form, and a medical information handout;
ordering one or more of a drug prescription, a laboratory test, and a medical procedure; and
notifying a user of one or more of a drug interaction, a recommended medical procedure, and a result of at least one of a previous medical procedure, previous laboratory test, and a failure of said patient to follow-up to a physician request.

14. The method of claim 13, wherein said providing step includes storing said medical record on a computer-accessible network, said network accessible to a plurality of users.

15. The method of claim 13, wherein said providing step includes displaying said medical record to said user.

16. The method of claim 13, wherein said medical information handout includes one or more of symptoms for said patient to be aware of and directions to said patient to treat one or more symptoms.

17. The method of claim 16, wherein said handout is customizable to said patient.

18. The method of claim 13, wherein said ordering step includes communicating one or more of said prescription, test, and procedure via a network to one or more of a pharmacy, a hospital, and a physician.

19. The method of claim 13, wherein said drug interaction is one or more of an adverse drug reaction and a known drug allergy interaction.

20. The method of claim 13, wherein said entering step includes activating a graphical icon.

21. The method of claim 13, wherein said performing step is based on a comparison of said input to a criteria list, said criteria list being customizable to one or more physicians.

22. A macro-enhanced clinical workflow system, said system including:
an electronic medical record associated with a patient, said medical record including a patient medical history; and
a set of instructions stored on a computer-readable medium, said instructions directing an output device to automatically perform one or more of the steps of:
printing one or more of a prescription form, a laboratory test form, and a medical information handout,
ordering one or more of a drug prescription, a laboratory test, and a medical procedure, and
notifying said user of one or more of a drug interaction, a recommended medical procedure, and a result of at least one of a previous medical procedure, previous laboratory test, and a failure of said patient to follow-up to physician request,
wherein said instructions direct said output device based on at least a comparison of user input added to said medical record and one or more of said medical record and a criteria list.

23. The system of claim 22, wherein said medical record is stored on a computer-accessible network, said network accessible to a plurality of users.

24. The system of claim 22, further including a display device presenting said medical record to said user.

25. The system of claim 22, wherein said medical information handout includes one or more of symptoms for said patient to be aware and directions to said patient to treat one or more symptoms.

26. The system of claim 25, wherein said handout is customizable to said patient.

27. The system of claim 22, wherein said output device orders one or more of said prescription, test, and procedure via a network to one or more of a pharmacy, a hospital, and a physician.

28. The system of claim 22, wherein said drug interaction is one or more of an adverse drug reaction and a known drug allergy.

29. The system of claim 22, wherein said user input includes a user activating a graphical icon.

30. The system of claim 22, wherein said criteria list is customizable to one or more physicians.

31. A method for automating an electronic medical record system, said method including:
adding medical data to an electronic medical record;
comparing said medical data to second medical data previously added to said medical record; and
based on at least said comparing step, communicating at least one of a notification, an alert, and a recommendation to a user.

32. The method of claim 31, wherein said adding step includes said medical record being stored on computer-readable memory accessible via a network.

33. The method of claim 31, wherein said notification includes one or more of an audio and visual communication.

34. The method of claim 31, wherein said notification includes one or more of a medical procedure and symptom.

35. The method of claim 31, wherein said alert includes a communication of one or more of a possible adverse drug reaction and a known drug allergy.

36. The method of claim 31, wherein said recommendation includes at least one of a recommended drug prescription, medical procedure, medical treatment plan and laboratory test.

37. The method of claim 31, wherein said adding step includes a user activating a graphical icon.
